(19) United States
(12) Patent Application Publication
(10) Pub. No.: US 2018/0227931 A1
(43) Pub. Date: Aug. 9, 2018

(54) Method for Radio Resource Access and Terminal Device

(71) Applicant: Telefonaktiebolaget LM Ericsson (publ), Stockholm (SE)

(72) Inventors: Jinhua LIU, Beijing (CN); Gen LI, Beijing (CN); Cong SHI, Beijing (CN)

(21) Appl. No.: 15/544,822

(22) PCT Filed: Jul. 11, 2016
(86) PCT No.: PCT/CN2016/089622

§ 371 Date: Jul. 19, 2017

(51) Int. Cl. H04W 72/10; H04W 72/04

(52) U.S. Cl. CPC H04W 72/10; H04W 72/048

(57) ABSTRACT

The present disclosure provides a method (100) in a terminal device for radio resource access. The method (100) comprises: determining (S110) a terminal group to which the terminal device belongs, the terminal group having a first group priority; accessing (S120) radio resources that do not conflict with any terminal device belonging to any terminal group having a higher group priority than the first group priority.

### TECHNICAL FIELD

The present disclosure relates to radio communications, and more particularly, to a method for radio resource access and a terminal device.

### BACKGROUND

Contention-based uplink access, also known as Instant Uplink Access (IUA) in Long Term Evolution (LTE), is expected to be used in the future communication networks over both licensed and unlicensed spectrums.

In the contention-based uplink access, an uplink grant is transmitted to a terminal device, or User Equipment (UE), to configure a resource pool for contention-based access by the terminal device. More than one terminal device may be granted to transmit over the same resource pool. In this case, these terminal devices can contend for radio resources in the pool based on predefined rules.

Such contention-based uplink access can greatly reduce the uplink access latency and overhead, especially for small data transmissions. In the future communication networks, there will be a huge number of connections from various terminal devices including e.g., smart phones and Machine Type Communication (MTC) terminals. Each terminal device may occasionally generate a small amount of data but the overall capacity required for such small data transmissions may be enormous. The contention-based uplink access, with both reduced latency and improved capacity, is particularly advantageous for the small data transmissions.

However, in order to restrict a collision ratio among terminal devices contending for a set of radio resources to a low level, the contention based uplink access may have a low resource utilization ratio.

There is thus a need for an improved solution for radio resource access to enhance the resource utilization ratio in case of contention-based access.

### SUMMARY

It is an object of the present disclosure to provide a method for radio resource access and a terminal device, capable of achieving an improved resource utilization ratio while maintaining a low collision ratio.

In a first aspect, a method in a terminal device for radio resource access is provided. The method comprises: determining a terminal group to which the terminal device belongs, the terminal group having a first group priority; accessing radio resources that do not conflict with any terminal device belonging to any terminal group having a higher group priority than the first group priority.

In an embodiment, when the first group priority is the highest group priority, the step of accessing comprises: selecting a resource block in a Transmission Time Interval (TTI) for accessing. The method further comprises: transmitting an indicator in a search space associated with the terminal group in the selected resource block, the indicator indicating an occupied state of the selected resource block.

In an embodiment, when the first group priority is not the highest group priority, the step of accessing comprises: determining, for each terminal group having a higher group priority than the first group priority, whether a resource block in a Transmission Time Interval (TTI) is occupied by any terminal device belonging to that terminal group, by monitoring whether there is an indicator indicating an occupied state of the resource block in a search space associated with that terminal group.

In an embodiment, the step of accessing further comprises: selecting a resource block in the TTI that is not occupied by any terminal device belonging to any terminal group having a higher group priority than the first group priority for accessing.

In an embodiment, the indicator further indicates a multiplexing code associated with the resource block. The step of accessing further comprises: selecting the resource block for accessing with another multiplexing code orthogonal to the multiplexing code.

In an embodiment, the method further comprises: transmitting an indicator in a search space associated with the terminal group in the selected resource block, the indicator indicating an occupied state of the selected resource block.

In an embodiment, the indicator is transmitted only when the first group priority is not the lowest group priority.

In an embodiment, the indicator is transmitted using an indicator sequence from a set of indicator sequences assigned to a cell where the terminal device is camping and orthogonal to any indicator sequence assigned to any cell neighboring to the cell.

In an embodiment, the indicator is transmitted using a resource pattern from a set of resource patterns assigned to a cell where the terminal device is camping and orthogonal to any resource pattern assigned to any cell neighboring to the cell.

In an embodiment, the indicator is transmitted over resources configured to the terminal device via system information or terminal specific signaling.

In an embodiment, the terminal group is determined based on an identifier (ID) of the terminal device.

In an embodiment, the terminal group is determined based on a terminal grouping configuration received from a network node.

In an embodiment, the terminal grouping configuration is based on at least one of: a number of terminal devices in each terminal group, a periodical traffic pattern associated with the terminal device, and a Quality of Service (QoS) requirement associated with the terminal device.

In an embodiment, the terminal group is determined randomly at the terminal device.

In a second aspect, a terminal device is provided. The terminal device comprises: a determining unit configured to determine a terminal group to which the terminal device belongs, the terminal group having a first group priority; an access unit configured to access radio resources that do not conflict with any terminal device belonging to any terminal group having a higher group priority than the first group priority.

In a third aspect, a terminal device is provided. The terminal device comprises a transceiver, a processor and a memory. The memory contains instructions executable by the processor whereby the terminal device is operative to: determine a terminal group to which the terminal device belongs, the terminal group having a first group priority; access radio resources that do not conflict with any terminal device belonging to any terminal group having a higher group priority than the first group priority.

The above embodiments of the first aspect are also applicable for the second and third aspects.

With the embodiments of the present disclosure, terminal devices sharing one single resource pool can be divided into a number of groups each having an associated group priority. A terminal device belonging to a group having a lower group priority only accesses radio resources that do not conflict with any terminal device belonging to any terminal group having a higher group priority. In this way, any collision between two different terminal groups can be eliminated. Meanwhile, the radio resources in the pool can be utilized as much as possible by the terminal devices, which results in an improved resource utilization ratio.

### BRIEF DESCRIPTION OF THE DRAWINGS

The above and other objects, features and advantages will be more apparent from the following description of embodiments with reference to the figures, in which:

FIG. 1 is a flowchart illustrating a method for radio resource access according to an embodiment of the present disclosure;

FIG. 2 is a schematic diagram showing an example explaining the method shown in FIG. 1;

FIG. 3 is a block diagram of a terminal device according to an embodiment of the present disclosure; and

FIG. 4 is a block diagram of a terminal device according to another embodiment of the present disclosure.

### DETAILED DESCRIPTION

The embodiments of the disclosure will be detailed below with reference to the drawings. It should be noted that the following embodiments are illustrative only, rather than limiting the scope of the disclosure.

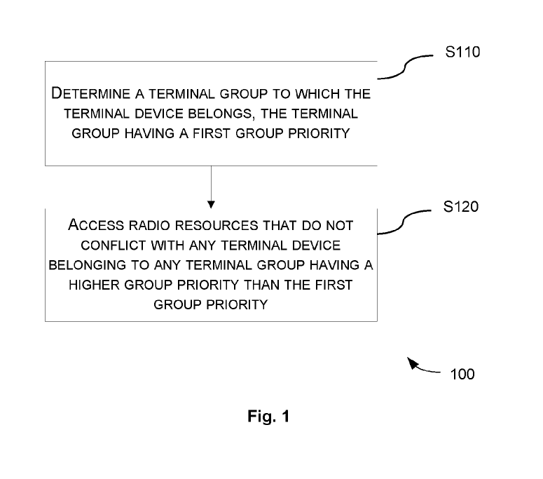

FIG. 1 is a flowchart illustrating a method 100 for radio resource access according to an embodiment of the present disclosure. The method 100 can be performed in a terminal device, e.g., a UE or a MTC terminal. The method 100 includes the following steps.

At step S110, the terminal device determines a terminal group to which the terminal device belongs. The terminal group has a first group priority.

In an example, the terminal group can be determined based on an identifier (ID) of the terminal device. For example, assuming that there are a predefined number, N, of terminal groups having indices of 1, 2, . . . , N, respectively, the index, i, of the terminal group to which the terminal device belongs can be determined according to:

i=ID mod N (1).

Here, the ID can be e.g., Cell—Radio Network Temporary Identifier (C-RNTI) of the terminal device. In this case, no explicit signaling is required for the terminal device to determine the terminal group it belongs to. In an example, the group priorities of the respective terminal groups can be associated with the indices. For instance, a terminal group having a smaller index may have a higher group priority, or vice versa.

Alternatively, the terminal group can be determined based on a terminal grouping configuration received from a network node. For example, the index, i, of the terminal group to which the terminal device belongs can be received from an evolved NodeB (eNB) via terminal specific signaling (e.g., along with an uplink grant for contention-based access). Here, the terminal grouping configuration may be based on a number of terminal devices in each terminal group. For example, for the purpose of fairness, a terminal group having a lower priority may include a smaller number of terminal devices, such that all terminal groups can have similar collision ratio. Additionally or alternatively, the terminal grouping configuration may be based on a periodical traffic pattern associated with the terminal device. For example, the eNB may observe that many terminal devices have their traffic following a periodical pattern, which is typically the case for MTC terminals. Accordingly, the terminal grouping can be configured such that terminal devices probably having simultaneous traffic will not be assigned to the same terminal group. Additionally or alternatively, the terminal grouping configuration may be based on a Quality of Service (QoS) requirement associated with the terminal device. For example, terminal devices having higher QoS requirements (e.g., stricter delay requirements) can be assigned to a terminal group having a higher priority.

Alternatively, the terminal group can be determined randomly at the terminal device. For example, the terminal device can select an index, i, of the terminal group randomly from 1, 2, . . . , N. Again in this case a terminal group having a smaller index may have a higher priority, or vice versa.

At step S120, the terminal device accesses radio resources that do not conflict with any terminal device belonging to any terminal group having a higher group priority than the first group priority.

When the first group priority is the highest group priority, in the step S120, the terminal device can select a resource block in a Transmission Time Interval (TTI) for accessing. Then, the terminal device can transmit an indicator in a search space associated with Group 1 in the selected resource block. The indicator indicates an occupied state of the selected resource block.

On the other hand, when the first group priority is not the highest group priority, in the step S120, the terminal device determines, for each terminal group having a higher group priority than the first group priority, whether a resource block in a Transmission Time Interval (TTI) is occupied by any terminal device belonging to that terminal group, by monitoring whether there is an indicator indicating an occupied state of the resource block in a search space associated with that terminal group.

Then, in an example, the terminal device selects a resource block in the TTI that is not occupied for accessing.

In another example, in addition to the occupied state, the indicator may further indicate a multiplexing code associated with the resource block. In this case, the terminal device can select the resource block for accessing with another multiplexing code orthogonal to the multiplexing code. One example of the multiplexing code can be Demodulation Reference Signal (DMRS) shift.

Then, the terminal device can transmit an indicator in a search space associated with the terminal group in the selected resource block. The indicator indicates an occupied state of the selected resource block, and possibly the multiplexing code associated with the selected resource block. In an example, the indicator is transmitted only when the first group priority is not the lowest group priority.

In an example, the indicator can be transmitted using an indicator sequence from a set of indicator sequences assigned to a cell where the terminal device is camping and orthogonal to any indicator sequence assigned to any cell neighboring to the cell. In this way, the indicators transmitted in neighboring cells will not interfere with each other.

Alternatively, the indicator is transmitted using a resource pattern from a set of resource patterns assigned to a cell where the terminal device is camping and orthogonal to any resource pattern assigned to any cell neighboring to the cell. The term “resource pattern” as used herein refers to time-frequency positions of resource elements used for transmitting the indicator. In this way, the indicators transmitted in neighboring cells are disposed in different time-frequency positions and thus will not interfere with each other.

Additionally or alternatively, the indicator can be transmitted over resources configured to the terminal device via system information or terminal specific signaling.

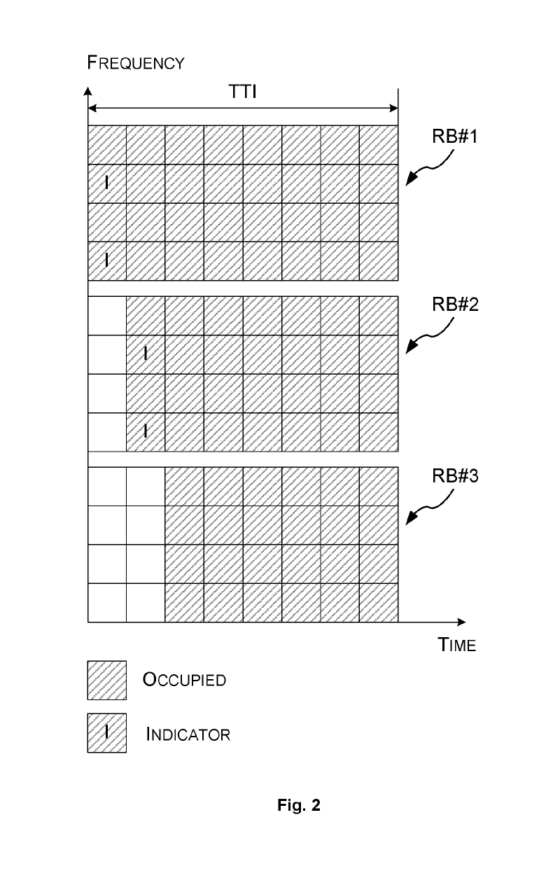

In the following, the above method 100 will be explained with reference to FIG. 2, which shows an exemplary resource occupation. For the purpose of illustration only, a resource pool including three resource blocks, RB#1, RB#2 and RB#3, is shown. Each resource block includes a number of resource elements each represented as squares. It is assumed here that there are N=3 terminal groups: Group 1, Group 2 and Group 3, with Group 1 having the highest group priority and Group 3 having the lowest group priority. It is also assumed here that there are three terminal devices, T1, T2 and T3, belonging to Group 1, Group 2 and Group 3, respectively.

The terminal device T1, which belongs to Group 1 having the highest group priority, selects RB#1 for accessing and transmits an indicator in a search space associated Group 1 in RB#1, indicating an occupied state of RB#1. In the example shown in FIG. 2, the search space includes two resource elements labeled as “I” in the first symbol in the TTI. The entire RB#1 is occupied by the terminal device T1.

The terminal device T2 belonging to Group 2 does not contend for radio resources from the first symbol. Instead, for each resource block in the resource pool, it monitors in the first symbol whether there is an indicator indicating an occupied state of the resource block in the search space associated Group 1. Here, the terminal device T2 detects the indicator transmitted by terminal device T1 in RB#1 and learns that RB#1 has been occupied by T1. Hence, the terminal device T2 selects a resource block that is not occupied (RB#2 in this example) for accessing. The terminal device T2 also transmits an indicator in a search space associated with Group 2 in RB#2, indicating an occupied state of RB#2. In the example shown in FIG. 2, the search space includes two resource elements labeled as “I” in the second symbol in the TTI. All resource elements in RB#2, other than those in the first symbol, are occupied by the terminal device T2.

It is to be noted here that, when orthogonal multiplexing codes are possible, the terminal device T2 can also select RB#1 for accessing, but with a different multiplexing code from the one used by the terminal device T1.

Similarly, for each resource block in the resource pool, the terminal device T3 belonging to Group 3 monitors in the first symbol whether there is an indicator indicating an occupied state of the resource block in the search space associated Group 1, and monitors in the second symbol whether there is an indicator indicating an occupied state of the resource block in the search space associated Group 2. Here, the terminal device T3 detects the indicator transmitted by terminal device T1 in RB#1 and the indicator transmitted by terminal device T2 in RB#2. Accordingly, it learns that RB#1 has been occupied by T1 and RB#2 has been occupied by T2. Hence, the terminal device T3 selects a resource block that is not occupied (RB#3 in this example) for accessing. All resource elements in RB#3, other than those in the first and second symbols, are occupied by the terminal device T3.

Again, when orthogonal multiplexing codes are possible, the terminal device T3 can also select RB#1 (or RB#2) for accessing, but with a different multiplexing code from the one used by the terminal device T1 (or T2).

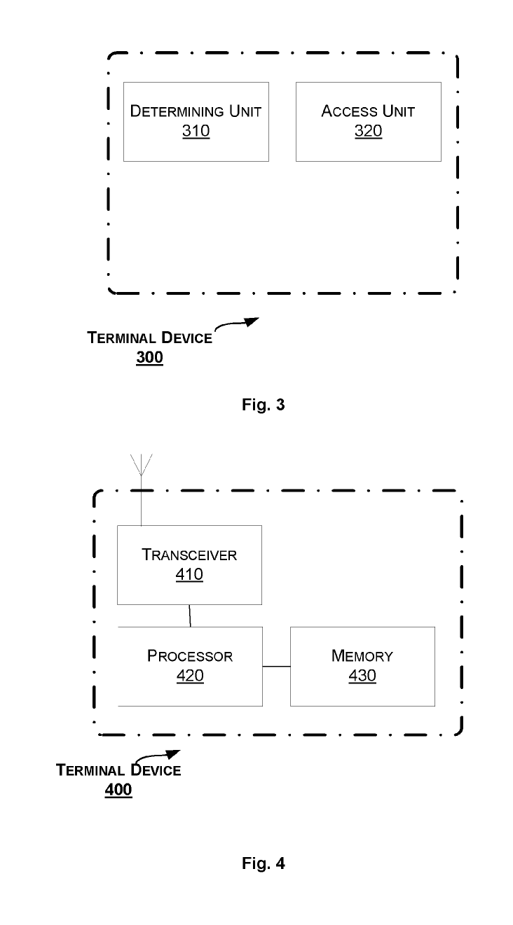

Correspondingly to the method 100 as described above, a terminal device is provided. FIG. 3 is a block diagram of a terminal device 300 for radio resource access according to an embodiment of the present disclosure. The terminal device 300 can be e.g., a UE or a MTC terminal.

As shown in FIG. 3, the terminal device 300 includes a determining unit 310 configured to determine a terminal group to which the terminal device belongs, the terminal group having a first group priority. The terminal device 300 further includes an access unit 320 configured to access radio resources that do not conflict with any terminal device belonging to any terminal group having a higher group priority than the first group priority.

In an embodiment, the access unit 320 is configured to, when the first group priority is the highest group priority: selecting a resource block in a Transmission Time Interval (TTI) for accessing. The terminal device 300 further includes a transmitting unit (not shown) configured to transmit an indicator in a search space associated with the terminal group in the selected resource block, the indicator indicating an occupied state of the selected resource block.

In an embodiment, the access unit 320 is configured to, when the first group priority is not the highest group priority: determine, for each terminal group having a higher group priority than the first group priority, whether a resource block in a Transmission Time Interval (TTI) is occupied by any terminal device belonging to that terminal group, by monitoring whether there is an indicator indicating an occupied state of the resource block in a search space associated with that terminal group.

In an embodiment, the access unit 320 is further configured to select a resource block in the TTI that is not occupied for accessing.

In an embodiment, the indicator further indicates a multiplexing code associated with the resource block. The access unit 320 is further configured to select the resource block for accessing with another multiplexing code orthogonal to the multiplexing code.

In an embodiment, the terminal device 300 further includes a transmitting unit (not shown) configured to transmit an indicator in a search space associated with the terminal group in the selected resource block, the indicator indicating an occupied state of the selected resource block.

In an embodiment, the indicator is transmitted only when the first group priority is not the lowest group priority.

In an embodiment, the indicator is transmitted using an indicator sequence from a set of indicator sequences assigned to a cell where the terminal device is camping and orthogonal to any indicator sequence assigned to any cell neighboring to the cell.

In an embodiment, the indicator is transmitted using a resource pattern from a set of resource patterns assigned to a cell where the terminal device is camping and orthogonal to any resource pattern assigned to any cell neighboring to the cell.

In an embodiment, the indicator is transmitted over resources configured to the terminal device via system information or terminal specific signaling.

In an embodiment, the terminal group is determined based on an identifier (ID) of the terminal device.

In an embodiment, the terminal group is determined based on a terminal grouping configuration received from a network node.

In an embodiment, the terminal grouping configuration is based on at least one of: a number of terminal devices in each terminal group, a periodical traffic pattern associated with the terminal device, and a Quality of Service (QoS) requirement associated with the terminal device.

In an embodiment, the terminal group is determined randomly at the terminal device.

Each of the units 510-520 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 1.

FIG. 4 is a block diagram of a terminal device 400 according to another embodiment of the present disclosure.

The terminal device 400 can be provided for radio resource access. The terminal device 400 includes a transceiver 410, a processor 420 and a memory 430. The memory 430 contains instructions executable by the processor 420 whereby the terminal device 400 is operative to: receive from a terminal device a radio capability indication indicating one or more radio capabilities of the terminal device and one or more radio capabilities of radio access networks as detected by the terminal device; generate a traffic steering policy based on the radio capability indication; and transmit the traffic steering policy to the terminal device.

The present disclosure also provides at least one computer program product in the form of a non-volatile or volatile memory, e.g., an Electrically Erasable Programmable Read-Only Memory (EEPROM), a flash memory and a hard drive. The computer program product includes a computer program. The computer program includes: code/computer readable instructions, which when executed by the processor 420 causes the terminal device 400 to perform the actions, e.g., of the procedure described earlier in conjunction with FIG. 1.

The computer program product may be configured as a computer program code structured in computer program modules. The computer program modules could essentially perform the actions of the flow illustrated in FIG. 1.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1. A method in a terminal device for radio resource access, comprising:
determining a terminal group to which the terminal device belongs, the terminal group having a first group priority;
accessing radio resources that do not conflict with any terminal device belonging to any terminal group having a higher group priority than the first group priority.

2. The method of claim 1, wherein, when the first group priority is the highest group priority, said accessing comprises: selecting a resource block in a Transmission Time Interval (TTI) for accessing, and
wherein the method further comprises:
transmitting an indicator in a search space associated with the terminal group in the selected resource block, the indicator indicating an occupied state of the selected resource block.

3. The method of claim 1, wherein, when the first group priority is not the highest group priority, said accessing comprises: determining, for each terminal group having a higher group priority than the first group priority, whether a resource block in a Transmission Time Interval (TTI) is occupied by any terminal device belonging to that terminal group, by monitoring whether there is an indicator indicating an occupied state of the resource block in a search space associated with that terminal group.

4. The method of claim 3, wherein said accessing further comprises: selecting a resource block in the TTI that is not occupied by any terminal device belonging to any terminal group having a higher group priority than the first group priority for accessing.

5. The method of claim 3, wherein the indicator further indicates a multiplexing code associated with the resource block, and
wherein said accessing further comprises: selecting the resource block for accessing with another multiplexing code orthogonal to the multiplexing code.

6. The method of claim 5, further comprising:
transmitting an indicator in a search space associated with the terminal group in the selected resource block, the indicator indicating an occupied state of the selected resource block.

7. The method of claim 6, wherein the indicator is transmitted only when the first group priority is not the lowest group priority.

8. The method of claim 2, wherein the indicator is transmitted using an indicator sequence from a set of indicator sequences assigned to a cell where the terminal device is camping and orthogonal to any indicator sequence assigned to any cell neighboring to the cell.

9. The method of claim 2, wherein the indicator is transmitted using a resource pattern from a set of resource patterns assigned to a cell where the terminal device is camping and orthogonal to any resource pattern assigned to any cell neighboring to the cell.

10. The method of claim 2, wherein the indicator is transmitted over resources configured to the terminal device via system information or terminal specific signaling.

11. (canceled)

12. (canceled)

13. (canceled)

14. (canceled)

15. A terminal device, comprising:
a determining unit configured to determine a terminal group to which the terminal device belongs, the terminal group having a first group priority;
an access unit configured to access radio resources that do not conflict with any terminal device belonging to any terminal group having a higher group priority than the first group priority.

16. The terminal device of claim 15, wherein the access unit is configured to, when the first group priority is the highest group priority: selecting a resource block in a Transmission Time Interval (TTI) for accessing, and
wherein the terminal device further comprises:
a transmitting unit configured to transmit an indicator in a search space associated with the terminal group in the selected resource block, the indicator indicating an occupied state of the selected resource block.

17. The terminal device of claim 15, wherein the access unit is configured to, when the first group priority is not the highest group priority: determine, for each terminal group having a higher group priority than the first group priority, whether a resource block in a Transmission Time Interval (TTI) is occupied by any terminal device belonging to that terminal group, by monitoring whether there is an indicator indicating an occupied state of the resource block in a search space associated with that terminal group.

18. The terminal device of claim 17, wherein the access unit is further configured to select a resource block in the TTI that is not occupied by any terminal device belonging to any terminal group having a higher group priority than the first group priority for accessing.

19. The terminal device of claim 17, wherein the indicator further indicates a multiplexing code associated with the resource block, and
wherein the access unit is further configured to select the resource block for accessing with another multiplexing code orthogonal to the multiplexing code.

20. The terminal device of claim 18, further comprising:
a transmitting unit configured to transmit an indicator in a search space associated with the terminal group in the selected resource block, the indicator indicating an occupied state of the selected resource block.

21. The terminal device of claim 20, wherein the indicator is transmitted only when the first group priority is not the lowest group priority.

22. (canceled)

23. (canceled)

24. (canceled)

25. (canceled)

26. (canceled)

27. (canceled)

28. (canceled)
